(19) United States
(12) Patent Application Publication
(10) Pub. No.: US 2022/0021585 A1
(43) Pub. Date: Jan. 20, 2022

(54) CLUSTER MANAGEMENT OF EDGE COMPUTE NODES

(71) Applicant: Cisco Technology, Inc., San Jose, CA (US)

(72) Inventors: Robert E. Barton, Richmond (CA); Stephan Edward Friedl, Frederick, CO (US); Anoop Mohan, San Ramon, CA (US); Norbert Heusser, Bornheim (DE); Yogesh Kumar Soni, Fremont, CA (US); Daniel Eckstein, Bonn (DE)

(21) Appl. No.: 16/931,879

(22) Filed: Jul. 17, 2020

(51) Int. Cl. H04L 12/24; H04L 12/26; H04L 12/66

(52) U.S. Cl. CPC H04L 41/12; H04L 12/66; H04L 41/0668; H04L 43/16

(57) ABSTRACT

In one embodiment, a controller assigns a set of one or more endpoints in a network to a particular edge networking device in the network to process data generated by those one or more endpoints prior to sending the data to a remote application. The controller monitors performance metrics for the particular edge networking device. The controller makes, based on the performance metrics, a determination that performance of the particular edge networking device is below a defined threshold. The controller re-assigns, based on the determination, at least a portion of the set of one or more endpoints to a second edge networking device in the network.

### TECHNICAL FIELD

The present disclosure relates generally to computer networks, and, more particularly, to cluster management of edge compute nodes.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room when a person enters the room. Vehicles are another class of ‘things’ that are being connected via the IoT for purposes of sharing sensor data, implementing self-driving capabilities, monitoring, and the like.

As the IoT evolves, the variety of IoT devices will continue to grow, as well as the number of applications associated with the IoT devices. For instance, multiple cloud-based, business intelligence (BI) applications may take as input measurements captured by a particular IoT sensor. The lack of harmonization between data consumers, however, can lead to overly complicated data access policies, virtual models of IoT devices (e.g., ‘device twins’ or ‘device shadows’) that are often not portable across cloud providers, and increased resource consumption.

The networking devices at the edge of the IoT network are also potential failure points between the endpoint devices in the network and their cloud-hosted applications. This means that an IoT device failing to report its data to a cloud-hosted application could potentially be flagged as having failed, even though it was an intermediate networking device that had actually failed.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example network architecture for edge to multi-cloud processing and governance;

FIGS. 4A-4B illustrate examples of data processing by an edge device in a network;

FIG. 5 illustrates an example of the application of a script to data extracted from traffic in a network;

FIG. 6 illustrates an example of cluster management of edge devices; and

FIG. 7 illustrates an example simplified procedure for cluster management of edge compute nodes.

### DESCRIPTION OF EXAMPLE EMBODIMENTS

### Overview

According to one or more embodiments of the disclosure, a controller assigns a set of one or more endpoints in a network to a particular edge networking device in the network to process data generated by those one or more endpoints prior to sending the data to a remote application. The controller monitors performance metrics for the particular edge networking device. The controller makes, based on the performance metrics, a determination that performance of the particular edge networking device is below a defined threshold. The controller re-assigns, based on the determination, at least a portion of the set of one or more endpoints to a second edge networking device in the network.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

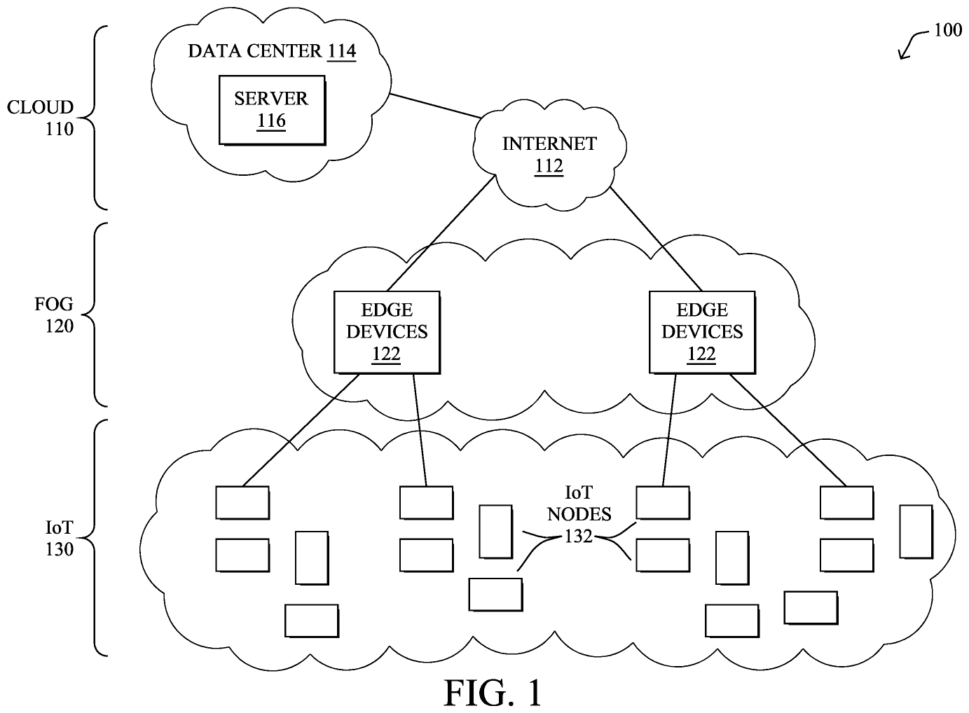

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), PLC protocols, or other shared-media protocols where appropriate. In this context, a protocol consists of a set of rules defining how the nodes interact with each other.

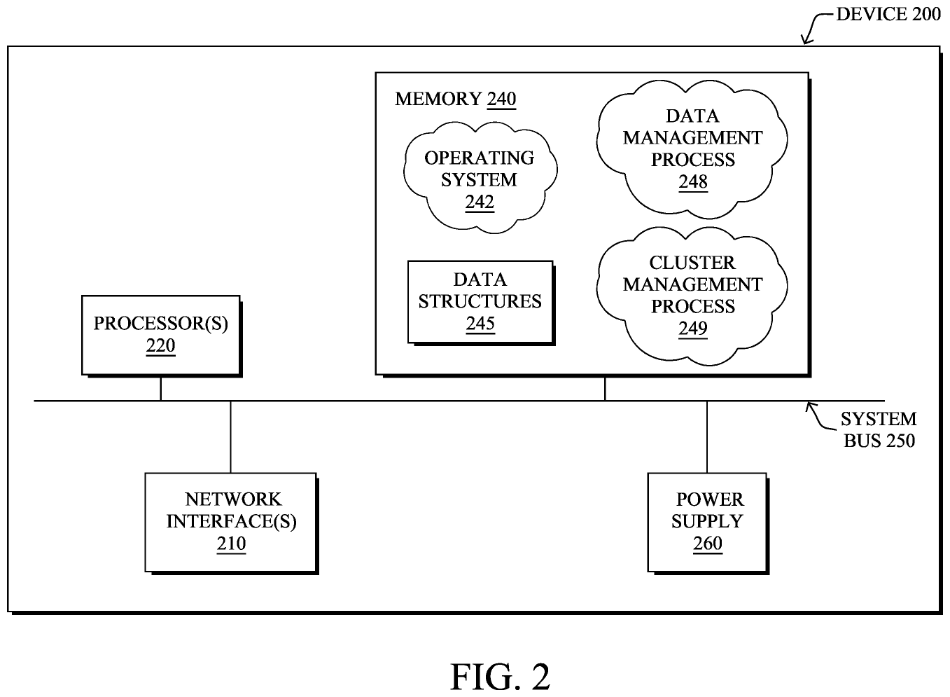

FIG. 2 is a schematic block diagram of an example node/device 200 (e.g., an apparatus) that may be used with one or more embodiments described herein, e.g., as any of the nodes or devices shown in FIG. 1 above or described in further detail below. The device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative data management process 248 and/or a cluster management process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

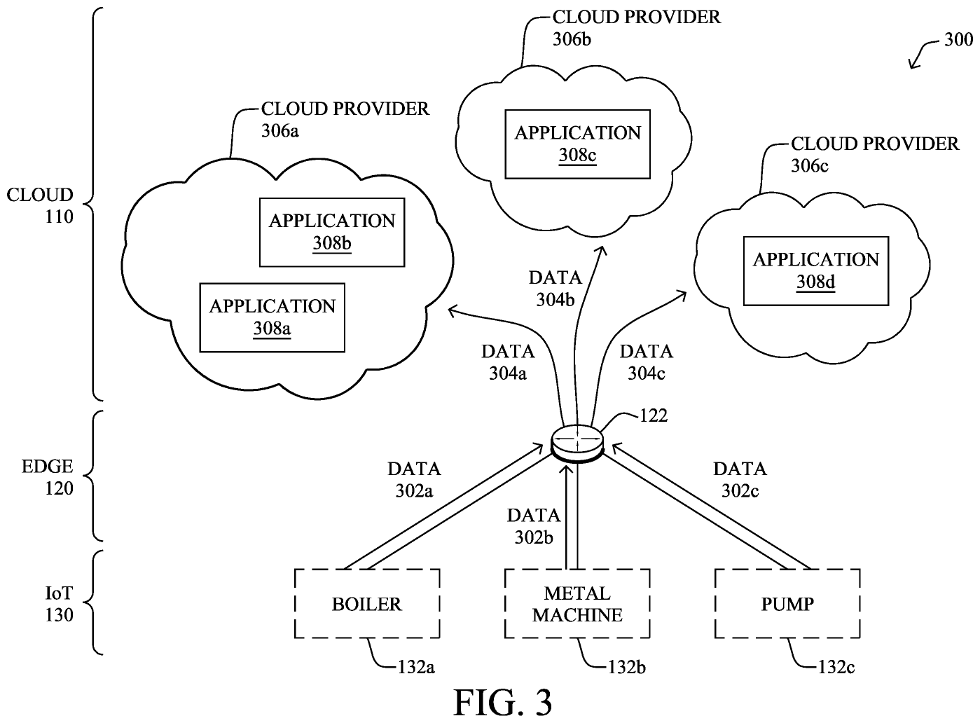

FIG. 3 illustrates an example network architecture 300 for edge to multi-cloud processing and governance, according to various embodiments. As shown, consider the case of an IoT network at IoT layer 130 that comprises a plurality of nodes 132, such as node 132a (e.g., a boiler), node 132b (e.g., a metal machine), and node 132c (e.g., a pump). Notably, the IoT network at IoT layer 130 may comprise any numbers of sensors and/or actuators. For instance, the network may be located in an industrial setting, such as a factory, port, substation, or the like, a smart city, a stadium, a conference or office building, or any other location in which IoT devices may be deployed.

As noted above, as the IoT evolves, the variety of IoT devices will continue to grow, as well as the number of applications associated with the IoT devices. As a result, multiple cloud-based applications may take as input measurements or other data. generated by a particular IoT device/node. For instance, as shown, assume that IoT nodes 132a-132c generate data 302a-302c, respectively, for consumption by any number of applications 308 hosted by different cloud providers 306, such as Microsoft Azure, Software AG, Quantela, MQTT/DC, or the like.

To complicate the collection and distribution of data 302a-302c, the different applications 308 may also require different sets of data 304a-304c from data 302a-302c. For instance, assume that cloud provider 306a hosts application 308a, which is a monitoring application used by the operator of the IoT network. In addition, cloud provider 306a may also host application 308b, which is a developer application that allows the operator of the IoT network to develop and deploy utilities and configurations for the IoT network. Another application, application 308c, may be hosted by an entirely different cloud provider 306b and be used by the vendor or manufacturer of a particular IoT node 132 for purposes. Finally, a further application, application 308d, may be hosted h a third cloud provider 306c, which is used by technicians for purposes of diagnostics and the like.

From the standpoint of the edge device 122, such as a router or gateway at the edge of the IoT network, the lack of harmonization between data consumers can lead to overly complicated data access policies, virtual models of IoT nodes 132 (e.g., ‘device twins’ or ‘device shadows’) that are often not portable across cloud providers 306, and increased resource consumption. In addition, different IoT nodes may communicate using different protocols within the IoT network. For instance, IoT nodes 132a-132c may communicate using MQTT, Modbus, OPC Unified Architecture (OPC UA), combinations thereof, or other existing communication protocols that are typically used in IoT networks. As a result, the various data pipelines must be configured on an individual basis at device 122 and for each of the different combinations of protocols and destination cloud providers 306.

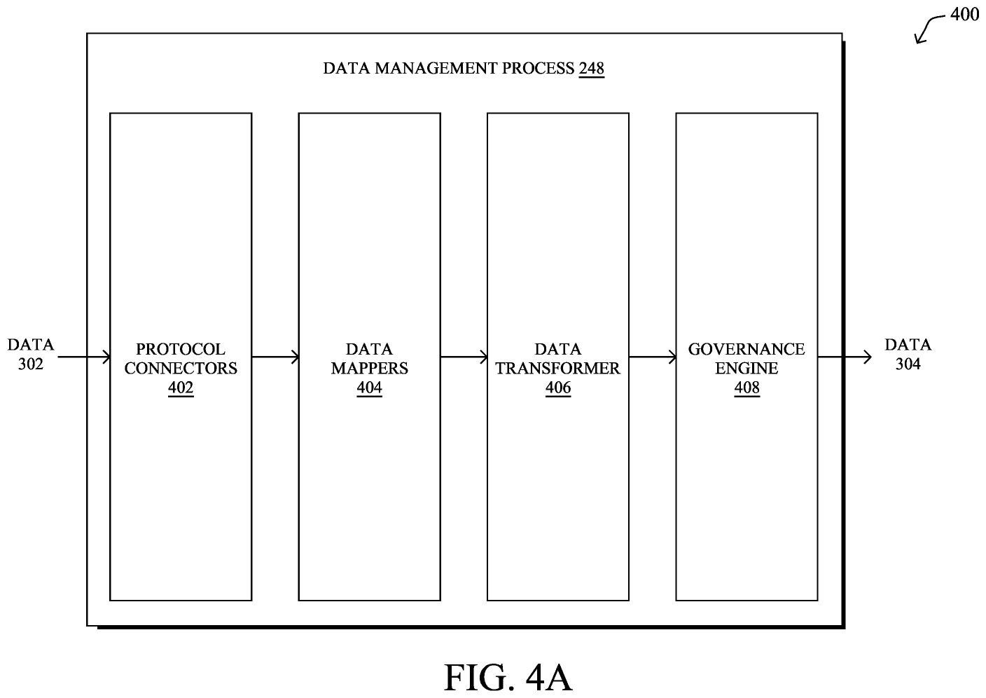

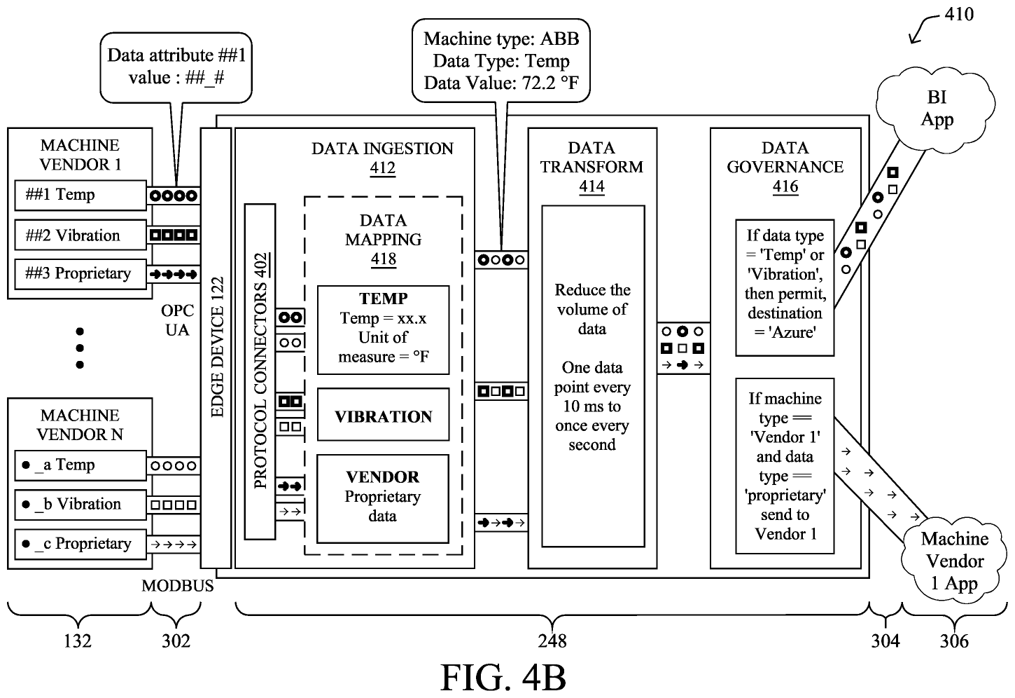

FIG. 4A illustrates an example architecture 400 for data management process 248, according to various embodiments. As shown, data management process 248 may comprise any or all of the following components: a plurality of protocol connectors 402, data mappers 404, a data transformer 406, and/or a governance engine 408. Typically, these components are executed on a single device located at the edge of the IoT network. However, further embodiments provide for these components to be executed in a distributed manner across multiple devices, in which case the combination of devices can be viewed as a singular device for purposes of the teachings herein. Further, functionalities of the components of architecture 400 may also be combined, omitted, or implemented as part of other processes, as desired.

During execution, protocol connectors 402 may comprise a plurality of southbound connectors that are able to extract data 302 from traffic in the IoT network sent via any number of different protocols. For instance, protocol connectors 402 may include connectors for OPC UA, Modbus, Ethernet/IP, MQTT, and the like. Accordingly, when the device executing data management process 248 (e.g., device 200) receives a message from the IoT network, such as a packet, frame, collection thereof, or the like, protocol connectors 402 may process the message using its corresponding connector to extract the corresponding data 302 from the message.

Once data management process 248 has extracted data 302 from a given message using the appropriate connector in protocol connectors 402, data mappers 404 may process the extracted data 302. More specifically, in various embodiments, data mappers 404 may normalize the extracted data 302. Typically, this may entail identifying the data extracted from the traffic in the network as being of a particular data type and grouping the data extracted from the traffic in the network with other data of the particular data type. In some instances, this may also entail associating a unit of measure with the extracted data 302 and/or converting a data value in one unit of measure to that of another.

In various embodiments, once data 302 has been extracted and normalized, data transformer 406 may apply any number of data transformation to the data. In some embodiments, data transformer 406 may transform data 302 by applying any number of mathematical and/or symbolic operations to it. For instance, data transformer 406 may apply a data compression or data reduction to the extracted and normalized data 302, so as to summarize or reduce the volume of data transmitted to the cloud. To do so, data transformer 406 may sample data 302 over time, compute statistics regarding data 302 (e.g., its mean, median, moving average, etc.), apply a compression algorithm to data 302, combinations thereof, or the like.

In further embodiments, data transformer 406 may apply analytics to the extracted and normalized data 302, so as to transform the data into a different representation, such as an alert or other indication. For instance, data transformer 406 may apply simple heuristics and/or thresholds to data 302, to transform data 302 into an alert. In another embodiment, data transformer 406 may apply machine learning to data 302, to transform the data.

In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Data transformer 406 may employ one or more supervised, unsupervised, or semi-supervised machine learning models. Generally, supervised learning entails the use of a training set of data that is used to train the model to apply labels to the input data. For example, the training data may include samples of ‘good’ readings or operations and ‘bad’ readings or operations that are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. For instance, an unsupervised model may Semi-supervised learning models take a middle ground approach that uses a greatly reduced set of labeled training data.

Example machine learning techniques that data transformer 406 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, deep learning models, or the like.

In further embodiments, data transformer 406 may comprise a scripting engine that allows developers to deploy any number of scripts to be applied to data 302 for purposes of the functionalities described above. For instance, an application developer may interface with application 308b shown previously in FIG. 3, to develop and push various scripts for execution by data transformer 406, if allowed to do so by policy. In other cases, previously developed scripts may also be pre-loaded into data transformer 406 and/or made available by the vendor or manufacturer of the device executing data management process 248 for deployment to data transformer 406.

According to various embodiments, another potential component of data management process 248 is governance engine 408 that is responsible for sending the data 302 transformed by data transformer 406 to any number of cloud providers as data 304. In general, governance engine 408 may control the sending of data 304 according to a policy. For instance, governance engine 408 may apply a policy that specifies that data 304 may be sent to a particular cloud provider and/or cloud-based application, but should not be sent to others. In some embodiments, the policy enforced by governance engine 408 may control the sending of data 304 on a per-value or per-data type basis. For instance, consider the case of an IoT node reporting a temperature reading and pressure reading. In such a case, governance engine 408 may send the temperature reading to a particular cloud provider as data 304 while restricting the sending of the pressure reading, according to policy.

As would be appreciated, by unifying the policy enforcement via governance engine 408, the various stakeholders in the data pipelines are able to participate in the creation and maintenance of the enforced policies. Today, the various data pipelines built to support the different network protocols and cloud vendors results in a disparate patchwork of policies that require a level of expertise that not every participant may possess. In contrast, by unifying the policy enforcement via governance engine 408, personnel such as security experts, data compliance representatives, technicians, developers, and the like can participate in the administration of the policies enforced by governance engine 408.

FIG. 4B illustrates an example 410 of the operation of data management process 248 during execution, according to various embodiments. As shown, assume that edge device 122 described previously (e.g., a device 200) executes data management process 248 at the edge of an IoT network that comprises IoT nodes 132. During operation, edge device 122 may communicate with IoT nodes 132 in the network that comprise devices from n-number of different vendors.

Each set of vendor devices in IoT nodes 132 may generate different sets of data, such as sensor readings, computations, or the like. For instance, the devices from a first machine vendor may generate data such as a proprietary data value, a temperature reading, and a vibration reading. Similarly, the devices from another machine vendor may generate data such as a temperature reading, a vibration reading, and another data value that is proprietary to that vendor.

As would be appreciated, the data 302 generated from each group of IoT nodes 132 may use different formats that are set by the device vendors or manufacturers. For instance, two machines from different vendors may both report temperature readings, but using different data attribute labels (e.g., “temp=,” “temperature=,” “##1,” “*_a,” etc.). In addition, the actual data values may differ by vendor, as well. For instance, the different temperature readings may report different levels of precision/number of decimals, use different units of measure (e.g., Celsius, Fahrenheit, Kelvin, etc.), etc.

Another way in which data 302 generated by IoT nodes 132 may differ is the network protocol used to convey data 302 in the network. For instance, the devices from one machine vendor may communicate using the OPC UA protocol, while the devices from another machine vendor may communicate using the Modbus protocol.

In response to receiving data 302 from IoT nodes 132, data management process 248 of edge device 122 may process data 302 in three stages: a data ingestion phase 412, a data transformation phase 414, and a data governance phase 416. These three processing phases operate in conjunction with one another to allow edge device 122 to provide data 304 to the various cloud providers 306 for consumption by their respective cloud-hosted applications.

During the data ingestion phase 412, protocol connectors 402 may receive messages sent by IoT nodes 132 in their respective protocols, parse the messages, and extract the relevant data 302 from the messages. For instance, one protocol connector may process OPC UA messages sent by one set of IoT nodes 132, while another protocol connector may process Modbus messages sent by another set of IoT nodes 132. Once protocol connectors 402 have extracted the relevant data 302 from the messages, data management process 248 may apply a data mapping 418 to the extracted data, to normalize the data 302. For instance, data management process 248 may identify the various types of reported data 302 and group them by type, such as temperature measurements, vibration measurements, and vendor proprietary data. In addition, the data mapping 418 may also entail standardizing the data on a particular format (e.g., a particular number of digits, unit of measure, etc.). The data mapping 418 may also entail associating metadata with the extracted data 302, such as the source device type, its vendor, etc.

During its data transformation phase 414, data management process 248 may apply various transformations to the results of the data ingestion phase 412. For instance, assume that one IoT node 132 reports its temperature reading every 10 milliseconds (ms). While this may be acceptable in the IoT network, and even required in some cases, reporting the temperature readings at this frequency to the cloud-providers may represent an unnecessary load on the WAN connection between edge device 122 and the cloud provider(s) 306 to which the measurements are to be reported. Indeed, a monitoring application in the cloud may only need the temperature readings at a frequency of once every second, meaning that the traffic overhead to the cloud provider(s) 306 can be reduced by a factor of one hundred by simply reporting the measurements at one second intervals. Accordingly, data transformation phase 414 may reduce the volume of data 304 sent to cloud provider(s) 306 by sending only a sampling of the temperature readings (e.g., every hundred), an average or other statistic(s) of the temperature readings in a given time frame, or the like.

During its data governance phase 416, data management process 248 may apply any number of different policies to the transformed data, to control how the resulting data 304 is sent to cloud provider(s) 306. For instance, one policy enforced during data governance phase 416 may specify that if the data type=‘Temp’ or ‘Vibration,’ then that data is permitted to be sent to destination=‘Azure,’ for consumption by a BI application hosted by Microsoft Azure. Similarly, another policy may specify that if the machine type=‘Vendor 1’ and the data type=‘proprietary,’ then the corresponding data can be sent to a cloud provider associated with the vendor.

In some embodiments, the policy enforced during data governance phase 416 may further specify how data 304 is sent to cloud providers 306. For instance, the policy may specify that edge device 122 should send data 304 to a particular cloud provider 306 via an encrypted tunnel, using a particular set of one or more protocols (e.g., MQTT), how the connection should be monitored and reported, combinations thereof, and the like.

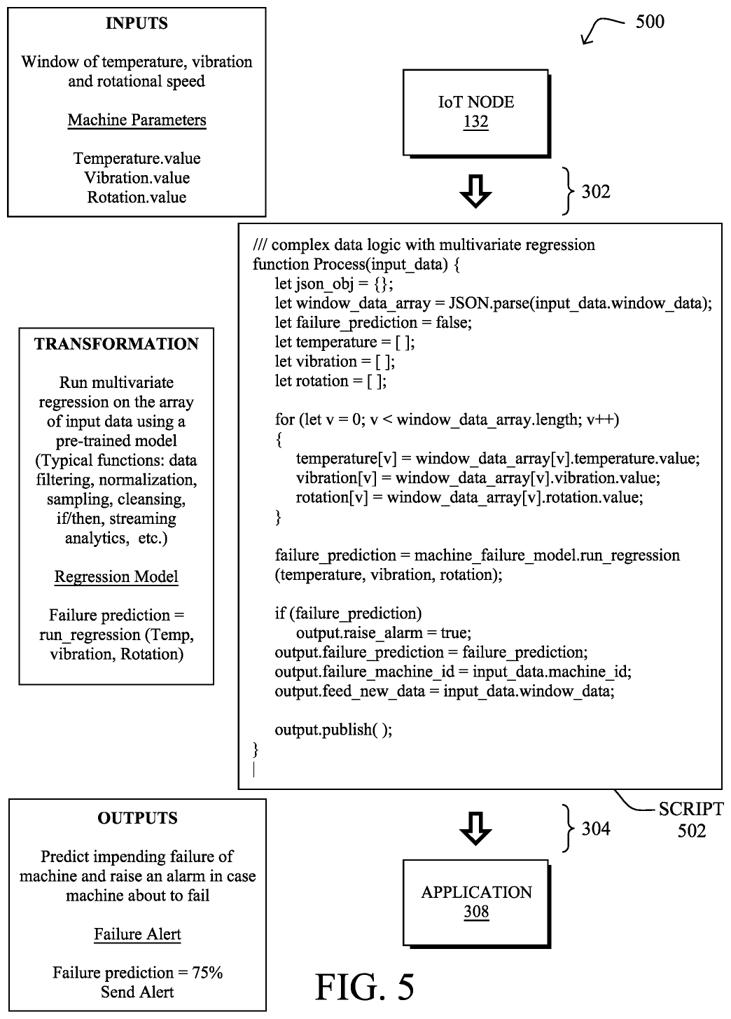

FIG. 5 illustrates an example 500 of the application of a script to data extracted from traffic in a network, according to various embodiments. As noted previously with respect to FIG. 4A, some embodiments of data transformer 406 provide for data transformer 406 to comprise a scripting engine, allowing for customization of the data transformations applied to the data from the IoT nodes 132. For instance, as shown, assume that IoT node 132 generates machine parameters, such as ‘temperature.value,’ ‘vibration.value,’ and ‘rotation.value,’ and sends these parameters to the edge device as data 302.

During its data transformation phase, the edge device may execute a script 502 that takes as input the data 302 provided by IoT node 132, potentially after normalization. In turn, script 502 may perform multivariate regression on the array of input data using a pre-trained machine learning model. Doing so allows script 502 to predict whether IoT node 132 is likely to fail, given its reported temperature, vibration, and rotation measurements. Depending on the results of this prediction, such as when the probability of failure is greater than a defined threshold (e.g., >75%), script 502 may output a failure alert that identifies IoT node 132, the probability of failure, or other information that may be useful to a technician or other user.

In cases in which script 502 generates an alert, the edge device may provide the alert as data 304 to one or more cloud providers for consumption by a cloud-hosted application, such as application 308, in accordance with its data governance policy. Since the input data from IoT node 132 has been extracted to be protocol-independent and normalized, this allows script 502 to predict failures across machines from different vendors. In addition, as the alerting is handled directly on the edge device, this can greatly reduce overhead on its WAN connection, as the edge device may only be required to report alerts under certain circumstances (e.g., when the failure probability is greater than a threshold), rather than reporting the measurements themselves for the analysis to be performed in the cloud.

### Cluster Management of Edge Compute Nodes

The techniques herein allow for the cluster management of edge networking devices, allowing for data synchronization and redundancy. In some aspects, backup devices can be assigned dynamically, so as to prevent a loss of connectivity and data, by treating the edge devices as nodes of a managed cluster.

Illustratively, the techniques described herein may be performed by hardware, software, and/or firmware, such as in accordance with the data management process 248, which may include computer executable instructions executed by the processor 220 (or independent processor of interfaces 210) to perform functions relating to the techniques described herein, in conjunction with cluster management process 249.

Specifically, according to various embodiments, a controller assigns a set of one or more endpoints in a network to a particular edge networking device in the network to process data generated by those one or more endpoints prior to sending the data to a remote application. The controller monitors performance metrics for the particular edge networking device. The controller makes, based on the performance metrics, a determination that performance of the particular edge networking device is below a defined threshold. The controller re-assigns, based on the determination, at least a portion of the set of one or more endpoints to a second edge networking device in the network.

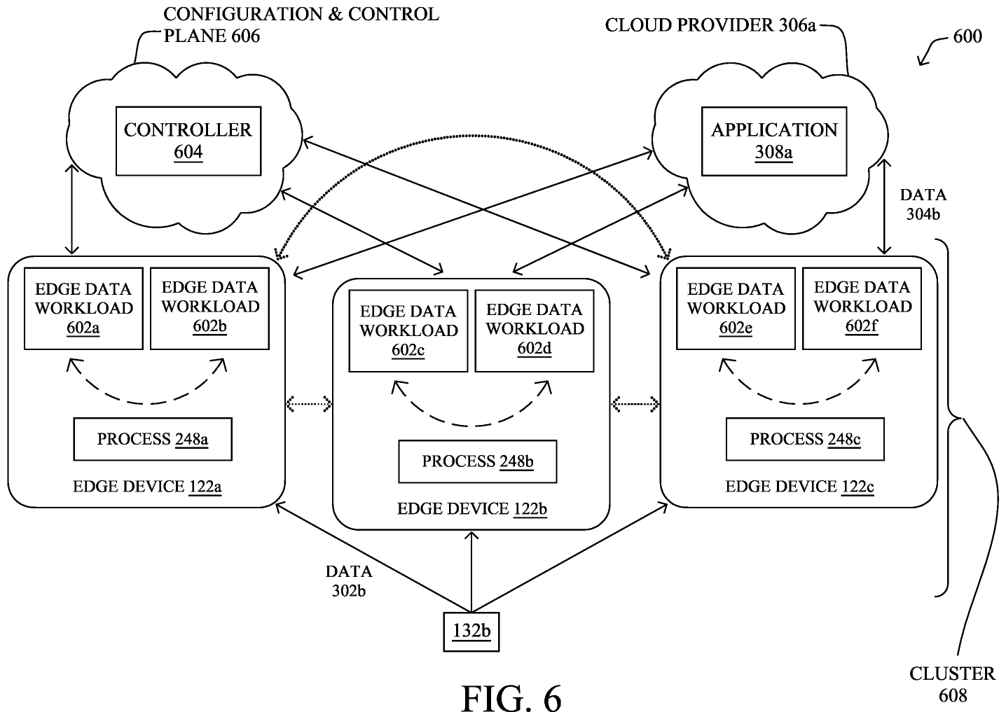

Operationally, FIG. 6 illustrates an example 600 of the cluster management of edge devices, according to various embodiments. Continuing the previous example of FIG. 3, assume that there are multiple networking devices, edge devices 122a-122c, located at the edge of the network in which IoT node 132b is an endpoint. For instance, edge devices 122a-122c may be switches, wireless access points, gateway routers, dedicated industrial compute nodes, or the like, each of which may execute its own corresponding copy of data management process 248.

Using the techniques described previously, IoT node 132b may send its data 302b to one of devices 122a-122c. In turn, the receiving device 122 may use its local copy of data management process 248 to process the received data 302a, such as by extracting data 302a using an appropriate protocol connector, normalizing/mapping data 302a, potentially performing a data transformation on data 302a, and sending the resulting data 304a to a cloud-hosted application, such as application 308a, according to policy. Accordingly, each of devices 122a-122c may maintain their own edge data workloads 602a-602b, 602c-602d, and 602e-602f, respectively.

As would be appreciated, having multiple nodes at the edge can help to afford redundancy to the specialized processing introduced herein, so that a failure of one device 122 does not prevent data generated by an IoT node 132, such as node 132b, from reaching its destination application(s) 308. To this end, in various embodiments, there may also be a controller 604 (e.g., a device 200) that communicates with devices 122a-122c via a configuration and control plane 606. In general, controller 604 may execute cluster management process 249 to provide supervisory control over devices 122a-122c.

In some embodiments, controller 604 may be located external to the network in which IoT node 132b is located, such as in a data center or the cloud. In further embodiments, controller 604 may be located within the network of IoT node 132b. In yet another embodiment, some or all of the functionalities of controller 604 may be implemented directly on any or all of devices 122a-122c (e.g., through execution of cluster management process 249).

During execution, controller 604 may leverage configuration and control plane 606 to monitor the states of devices 122a-122c, such as their application activity, resource consumptions and availabilities (e.g., CPU, memory, queues, etc.), event alarms, and/or other health information. Such information may be provided to controller 604 on a pull basis (e.g., in response to a request for the information by controller 604) or on a push basis (e.g., sent periodically without receiving an explicit request).

Controller 604 views the edge nodes of a location, such as devices 122a-122c, as a cluster 608 of devices organized in a geographical location, such as a factory or a refinery, etc. In turn, controller 604 may use the multiplicity of devices 122a-122c to dynamically load balance the connections with the IoT nodes, such as node 132b, across the edge networking devices, so that they operate in conjunction with one another as a high availability cluster. In one embodiment, devices 122a-122c may also share a common state, thereby forming a logical mesh.

As new IoT data connections are made from IoT nodes 132 to devices 122, controller 604 monitors the performance metrics of each device 122. If the performance of a particular device 122 is below a defined threshold, controller 604 may select another device 122 from cluster 608 as the data connection point. More specifically, when a new IoT node 132 is added to the network, controller 604 may assign a corresponding device 122 to it, to process the data generated by the node 132 and act as its data broker with respect to the cloud application(s) 308 that require the data. Controller 604 may base this assignment on the performance metrics that it receives from devices 122, so as to ensure that the workloads 602 of devices 122 are balanced or approximately balanced.

Once controller 604 has assigned a particular device 122 from cluster 608 to a node 132, controller 604 may interface with the application programming interface (API) of the node, to instruct it to become a collection point, for the IoT node 132 (e.g., connect to data from that device). For instance, controller 604 may send an instruction to device 122a via an API that assigns node 132b to device 122a as its data collection point in cluster 608.

If controller 604 determine that the performance of device 122a has fallen below a predefined threshold, based on the performance metrics reported to controller 604, controller 604 may re-assign node 132b to another one of devices 122 in cluster 608, according to various embodiments. In some cases, the performance threshold may be for a singular performance metric, such as the available memory or CPU resources of device 122a, its responsiveness, etc. In other cases, the threshold may be based on a combination of performance metrics regarding device 122a. When this occurs, controller 604 may re-assign some or all of the nodes 132 currently assigned to device 122a to either or both of devices 122b-122c, so as to spread the load across cluster 608. Note that the re-assignment is not a matter of how many IoT nodes 132 are connected, but rather the performance of device 122a itself and its ability to process data or other application functions.

To initiate the re-assignment of node 132b from device 122a to a second node in cluster 608, controller 604 may send corresponding instructions to these devices 122 via their APIs. For instance, assume that controller 604 has selected device 122b as the new data connection point for IoT node 132b, based on device 122b having the best overall system resources among the devices 122 in cluster 608 to meet the demands of more IoT connections. Controller 604 may perform a similar (re-)assignment function when new IoT nodes 132 are onboarded to the network, as well.

According to various embodiments, the re-assignment of IoT node 132b from device 122a to device 122b may initiate a graceful handoff between devices 122a-122b. To do so, device 122a may continue to ingest and broker data 302b from IoT node 132b until receiving an indication from controller 604 that device 122b has now connected to IoT node 132b and is correctly brokering data 302b. When this happens, device 122a will disconnect from IoT node 132b.

In another embodiment, controller 604 may base its assignment decisions on service level agreements (SLAs) associated with devices 122 in cluster 608. Controller 604 then monitors each device 122 for adherence to its SLA and, if the SLA is at risk, may initiate re-assignment of one or more of the IoT node 132 assigned to that device 1.22.

From the perspective of an IoT node, such as node 132b, the assignment and re-assignment to a device 122 in cluster 608 may be explicit or transparent, in various embodiments. In some embodiments, controller 604 may send an explicit instruction to IoT node 132h to use a particular gateway/device 122 when first joining the network and a subsequent instruction to use a different gateway/device 122 when re-assigned. In further embodiments, IoT node 132b may send data 302b to an anycast address associated with cluster 608. In turn, any device 122 in cluster 608 that is not a subscriber to IoT node 132b will ignore the packets of data 302b. Thus, re-assignment of node 132b may be achieved by changing the subscriptions used by devices 122 within cluster 608 with respect to the traffic sent to the anycast address associated with cluster 608.

As each node 132 is deployed in the network, controller 604 may examine the inventory of devices 122 in cluster 608 and assign a shadow backup to each of the devices 122 in case of failure, according to some embodiments. For instance, device 122b may be designated as the backup for device 122a by controller 604. The backup edge devices 122 are preprogrammed by controller 604 with the IoT nodes 132 to which they will connect, should the primary edge device 122 fail. Note that, in some instances, the load from the affected IoT nodes 132 may be spread across multiple edge devices 122 in cluster 608, to smooth the load demands. As a result of this mechanism, if a particular edge device 122 suddenly goes off-line or becomes unreachable for some reason, controller 604 immediately notifies the backup device 122 to begin accepting incoming data from devices that were previously managed by the device 122 that went off-line. Thus, if device 122a fails, device 122b may immediately begin accepting and processing data 302b on behalf of IoT node 132b.

By way of example, consider a factory that has fifty edge nodes spread throughout its plant floor. These edge nodes may connect to 15,000 endpoint IoT devices all generating data that is being ingested, normalized, labeled, and brokered in the edge nodes, depending on the data model. The controller for the edge nodes will have the responsibility of ensuring the load of data inputs is load balanced across all edge nodes. If an edge node dies for some reason, an appropriate backup is preassigned (part of the active cluster), and begins receiving data that was previously managed by the now dead edge node.

In a further embodiment, controller 604 may delegate the shedding and performance/SLA adherence functionality to one or more devices 122 within cluster 608. For instance, controller 604 may designate device 122b as a local controller for cluster 608. In such cases, device 122b may receive performance information from devices 122a and 122c, to make the assignment and re-assignment decisions.

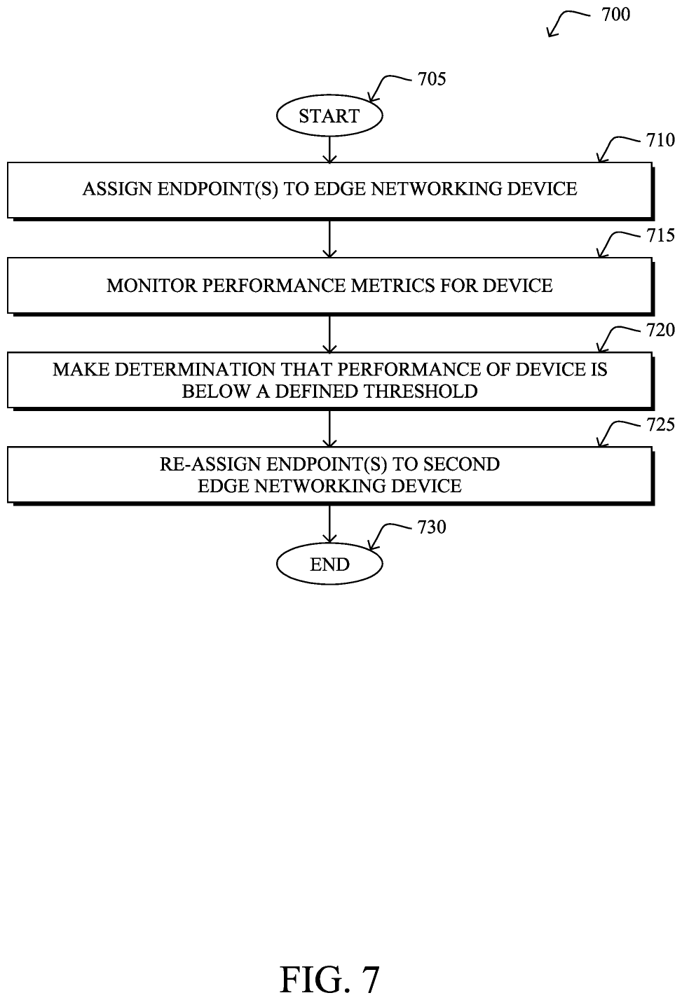

FIG. 7 illustrates an example simplified procedure for cluster management of edge compute nodes, in accordance with one or more embodiments described herein. The procedure 700 may start at step 705, and continues to step 710, where, as described in greater detail above, a controller (e.g., device 200 executing cluster management process 249) may assign a set of one or more endpoints in a network to a particular edge networking device in the network to process data generated by those one or more endpoints prior to sending the data to a remote application. For instance, the particular edge networking device may be responsible for extracting the data from traffic sent using a corresponding protocol connector, normalizing the data, applying a transformation to the data, and sending the data to one or more cloud-based applications according to policy. For instance, the particular edge networking device may comprise a gateway or router at the edge of the network.

At step 715, as detailed above, the controller may monitor performance metrics for the particular edge networking device. For instance, the performance metrics may be indicative of the available and/or consumed resources of the particular edge networking device (e.g., memory, CPU, etc.), events or alerts raised by the device, or other health information regarding the particular edge networking device.

At step 720, the controller may make a determination that performance of the particular edge networking device is below a defined threshold, as described in greater detail above. For instance, if the particular edge networking device fails to satisfy an SLA associated with the device, or other threshold for the performance metrics.

At step 725, as detailed above, the controller may re-assign, based on the determination, at least a portion of the set of one or more endpoints to a second edge networking device in the network. In some embodiments, the controller may do so by instructing at least one of the one or more endpoints to use a different destination gateway. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the cluster management of edge compute nodes. In some aspects, the techniques herein provide redundancy to the devices at the edge of the network so as to ensure that the data pipelines between endpoints in the network and cloud-hosted applications remain functional.

While there have been shown and described illustrative embodiments for cluster management of edge compute nodes (e.g., edge networking devices), it is to be understood that various other adaptations and modifications may be made within the intent and scope of the embodiments herein. For example, while specific protocols are used herein for illustrative purposes, other protocols and protocol connectors could be used with the techniques herein, as desired. Further, while the techniques herein are described as being performed by certain locations within a network, the techniques herein could also be performed at other locations, such as at one or more locations fully within the local network, etc.).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause an executing device to perform any or all of the functions herein. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
assigning, by a controller, a set of one or more endpoints in a network to a particular edge networking device in the network to process data generated by those one or more endpoints prior to sending the data to a remote application;
monitoring, by the controller, performance metrics for the particular edge networking device comprising available memory or CPU resources of the particular edge networking device;
making, by the controller and based on the performance metrics, a determination as to whether performance of the particular edge networking device is below a defined threshold; and
re-assigning, by the controller, at least a portion of the set of one or more endpoints to a second edge networking device in the network when it is determined that the performance of the particular edge networking device is below the defined threshold.

2. The method as in claim 1, wherein the particular edge networking device and the second edge networking device comprise network routers or gateways.

3. The method as in claim 1, wherein the one or more endpoints send the data to an anycast address in the network associated with the particular edge networking device and the second edge networking device.

4. The method as in claim 1, wherein the particular edge networking device processes the data in part by applying a data distribution policy to the data before sending the data to the remote application.

5. The method as in claim 1, further comprising:
identifying, by the controller, a new endpoint in the network; and
assigning, by the controller, the new endpoint to the second edge networking device, based on performance metrics for the second edge networking device.

6. The method as in claim 1, further comprising:
assigning, by the controller, the second edge networking device as a backup for the particular edge networking device, wherein the one or more endpoints send the data to the second edge networking device when the particular edge networking device is unreachable.

7. The method as in claim 1, wherein the particular edge networking device processes the data in part by using the data as input to a script executed by a scripting engine of the particular edge networking device.

8. The method as in claim 1, further comprising:
instructing, by the controller, the second edge networking device to re-assign the set of one or more endpoints to another edge networking device in the network when performance of the second edge networking device is below a defined threshold.

9. The method as in claim 1, wherein re-assigning, by the controller and based on the determination, at least a portion of the set of one or more endpoints to the second edge networking device in the network comprises:
instructing, by the controller, at least one of the one or more endpoints to use a different destination gateway.

10. An apparatus, comprising:
one or more network interfaces to communicate with a network;
a processor coupled to the one or more network interfaces and configured to execute one or more processes; and
a memory configured to store a process that is executable by the processor, the process when executed configured to:
assign a set of one or more endpoints in a network to a particular edge networking device in the network to process data generated by those one or more endpoints prior to sending the data to a remote application;
monitor performance metrics for the particular edge networking device comprising available memory or CPU resources of the particular edge networking device;
make, based on the performance metrics, a determination to whether performance of the particular edge networking device is below a defined threshold; and
re-assign at least a portion of the set of one or more endpoints to a second edge networking device in the network when it is determined that the performance of the particular edge networking device is below the defined threshold.

11. The apparatus as in claim 10, wherein the particular edge networking device and the second edge networking device comprise network routers or gateways.

12. The apparatus as in claim 10, wherein the one or more endpoints send the data to an anycast address in the network associated with the particular edge networking device and the second edge networking device.

13. The apparatus as in claim 10, wherein the particular edge networking device processes the data in part by applying a data distribution policy to the data before sending the data to the remote application.

14. The apparatus as in claim 10, wherein the process when executed is further configured to:
identify a new endpoint in the network; and
assign the new endpoint to the second edge networking device, based on performance metrics for the second edge networking device.

15. The apparatus as in claim 10, wherein the process when executed is further configured to:
assign the second edge networking device as a backup for the particular edge networking device, wherein the one or more endpoints send the data to the second edge networking device when the particular edge networking device is unreachable.

16. The apparatus as in claim 10, wherein the particular edge networking device processes the data in part by using the data as input to a script executed by a scripting engine of the particular edge networking device.

17. The apparatus as in claim 10, wherein the process when executed is further configured to:
instruct the second edge networking device to re-assign the set of one or more endpoints to another edge networking device in the network when performance of the second edge networking device is below a defined threshold.

18. The apparatus as in claim 10, wherein the apparatus re-assigns, based on the determination, at least a portion of the set of one or more endpoints to the second edge networking device in the network by:
instructing at least one of the one or more endpoints to use a different destination gateway.

19. The apparatus as in claim 10, wherein the apparatus is located outside of the network.

20. A tangible, non-transitory, computer-readable medium storing program instructions that cause a controller to execute a process comprising:
assigning, by the controller, a set of one or more endpoints in a network to a particular edge networking device in the network to process data generated by those one or more endpoints prior to sending the data to a remote application;
monitoring, by the controller, performance metrics for the particular edge networking device comprising available memory or CPU resources of the particular edge networking device;
making, by the controller and based on the performance metrics, a determination as to whether performance of the particular edge networking device is below a defined threshold; and
re-assigning, by the controller, at least a portion of the set of one or more endpoints to a second edge networking device in the network when it is determined that the performance of the particular edge networking device is below the defined threshold.
